(19) United States
(12) Patent Application Publication
(10) Pub. No.: US 2016/0164363 A1
(43) Pub. Date: Jun. 9, 2016

(54) CONNECTING DEVICE BETWEEN STATOR WINDING AND CONTROL DEVICE OF AN ELECTRICAL MACHINE

(71) Applicant: Robert Bosch GmbH, Stuttgart (DE)

(72) Inventors: Bernd Schroeder, Renningen (DE); Sridhar Selvaraj, Virudhunagar (IN); Mario Kaepple, Oehringen (DE)

(21) Appl. No.: 14/963,734

(22) Filed: Dec. 9, 2015

(30) Foreign Application Priority Data
Dec. 9, 2014 (DE) 10 2014 225 242.3

(51) Int. Cl. H02K 3/28; H02K 11/00

(52) U.S. Cl. CPC H02K 3/28; H02K 11/0068

(57) ABSTRACT

A connecting device having current rails (8-12) that produce an electrical connection between the stator winding and associated contact sites (35-39) of an electrical control device (6) of an electrical machine (1), the electrical control device being provided for controlling the stator winding, wherein the connecting device (5) comprises current rails (8-12) that protrude at the stator winding ends (18-22) in a parallel manner with respect to the middle axis of the electrical machine (1) and the current rails (8-12) lie in guide channels (32-34) that are arranged on a connection plate (31) that is embodied from an electrically non-conductive material.

### BACKGROUND OF THE INVENTION

The invention relates to a connecting device between the stator winding and a control device of an electrical machine.

Electrical machines that are used by way of example in motor vehicles as drives or as generators can be embodied as three-phase machines having a stator that comprises a stator winding and encompasses a rotor. In order to transmit torque, the rotor comprises a rotor shaft that is mounted in a rotatable manner in the housing of the electrical machine. In order to generate a rotational field that rotates in the stator, the stator winding of said stator is controlled by a control device that is arranged in the housing of the electrical machine. It is necessary for this purpose that the winding ends of the stator winding are connected by way of suitable electrical connections to associated contact sites of the control device. The electrical connections must be able to transmit high exciter currents and also comprise sufficient mechanical stability. However, it is also essential that the connecting lines are embodied altogether as one connecting device, in which the connecting lines are protected as far as possible against corrosion and creepage currents are prevented as reliably as possible from occurring between the connecting lines and the ground of the electrical machine. At the same time, it is necessary to take into consideration that when used in motor vehicles such electrical machines are exposed to intense environmental influences, such as moisture, contamination and vibrations.

DE 103 61 859 A1 discloses an electrical machine that can be used as a three-phase generator in motor vehicles. In the case of this known electrical machine, winding ends of the stator are connected to an additional conductor element that combines multiple individual wires of the winding ends by means of a clamp-like contact region. The conductor element that is used for this purpose is embodied as a metal piece that is closely encompassed in the region of the winding ends by an insulating part. Furthermore, the conductor element is embodied essentially from current rails that extend in a radial manner with respect to the middle axis of the electrical machine and produce an electrical connection to a control module across a region that is open to a great extent.

### SUMMARY OF THE INVENTION

In comparison to conventional connecting devices, the connecting device in accordance with the invention has the advantage that straight and relatively short current rails are used as a connection between the stator winding ends and the control device of an electrical machine; such current rails require a correspondingly reduced amount of material and can also be protected against corrosive influences very easily by means of a connection plate that is comparatively easy to produce. The current rails lie in guide channels of a connection plate that is embodied from a non-conductive material, wherein the guide channels represent an electrical insulation and provide protection against moisture or other environmental influences that can act on the current rails. The current rails are also protected in the guide channels against contamination so that creepage currents are reliably prevented from occurring between the current rails and the ground of the electrical machine.

It is preferred that the current rails comprise on the ends that are facing the stator winding ends in each case a clamping element with which the current rail is fixedly clamped to the stator winding end. It is preferred that the clamping element and the associated current rail form a one-piece metal part embodied from copper or any other material that has good electrically conductive characteristics. The current rails can be pre-assembled by being fixedly clamped to a respective stator winding end by means of the respective existing clamping element in order then to be soldered or welded to the stator winding ends. The clamping elements thus represent very advantageous assembly aids.

A particularly simple embodiment of such a clamping element resides in the fact that said clamping element is embodied as a u-shaped or v-shaped sheet metal bracket that protrudes bent at an angle from the current rails. A clamping element that is embodied in this manner can be very easily produced as a punched part on which the sheet metal bracket is then bent as required into the desired shape.

It is particularly advantageous to embody the guide channels on the connection plate in such a manner that said guide channels encompass with a small amount of play the current rails that are lying in said guide channels. It is thus possible that the current rails that are lying in said guide rails can be arranged with regard to the respective associated contact positions on the control device in a particular region in order to compensate for any existing position tolerances.

One preferred embodiment of the connecting device provides that the angle position of the stator winding ends that protrude at the stator winding in an axis-parallel manner with respect to the middle axis of the electrical machine essentially corresponds to the angle position of the associated contact site of the control device. It is consequently possible to provide clamping elements that are embodied as one unit on the current rails and in particular are arranged as one unit thereon. It is preferred that the stator winding ends are located at a smallest possible radial spacing from the respective associated contact sites so that the contact elements that are arranged at a bent angle on the current rails can be embodied correspondingly short.

All current rails of the connecting device are preferably identically embodied sheet metal parts, as a consequence of which these parts are simple to produce and also easy to store.

In the case of the preferred embodiment, the connecting device comprises current rails in the form of sheet metal strips that are arranged in a straight manner and comprise in each case a clamping element that has been formed as one thereon. It is particularly simple to produce such sheet metal strips and consequently also particularly cost-effective. Moreover, flat sheet metal strips that are arranged in a straight manner not only render it possible to save storage space but also require a correspondingly reduced amount of installation space when installed in an electrical machine.

### BRIEF DESCRIPTION OF THE DRAWINGS

The invention is further explained hereinunder by way of example with reference to the drawings, in which:

FIG. 1 illustrates a view of an electrical machine as it used as a three-phase generator or an electric drive in motor vehicles,

FIG. 2 illustrates a view of the winding head of an electrical machine with current rails that are arranged in an axis-parallel manner,

FIG. 3 illustrates a view as in FIG. 2 but with a housing cover covering the winding head,

FIG. 4 illustrates a view in accordance with FIG. 3 but with a connection plate that is placed on the housing cover, and

FIG. 5 illustrates a detailed view of the lower face of the connection plate that is evident in FIG. 4.

### DETAILED DESCRIPTION

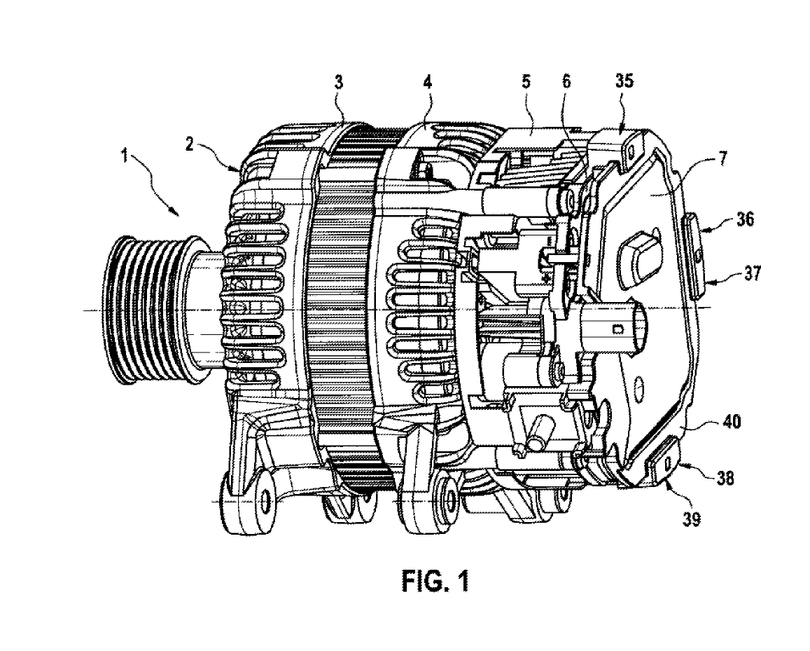

FIG. 1 illustrates an electrical machine 1 that has a stator 2 having two housing covers 3, 4. A conventional connecting device 5 is placed at the at the front end side on the housing cover 4 and said conventional connecting device comprises connecting lines, not illustrated in detail in the figure, by means of which an electrical connection is produced between the stator winding of the stator 2 and a control device 6. The control device 6 is sealed on the right hand end side by a cover 7.

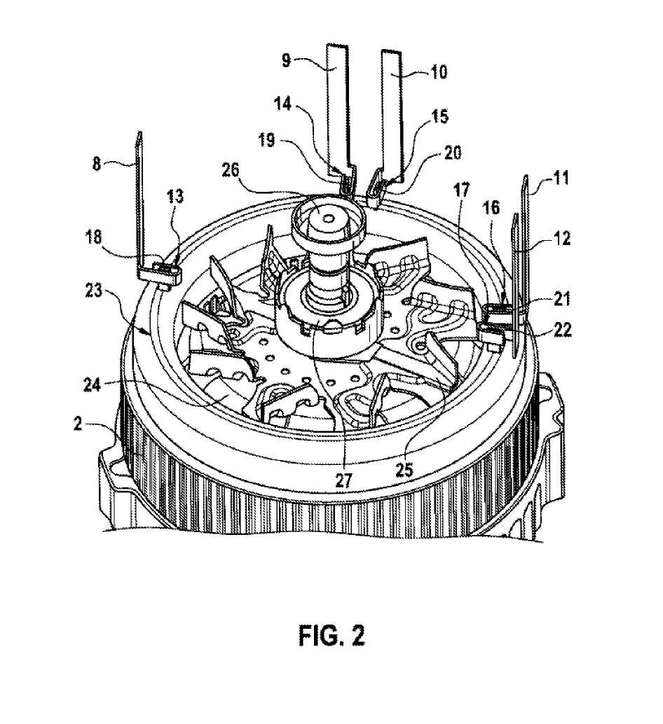

FIG. 2 illustrates the electrical conductor elements of the connecting device in accordance with the invention. Current rails 8 to 12 are used as connecting elements that are essentially embodied as straight sheet metal parts having in each case a clamping element 13 to 17 that protrudes at a right angle. The clamping elements 13 to 17 are placed on the stator winding ends 18 to 22 and clamped thereto. In order to produce a stable and also electrically safe and reliable connection, the clamping elements 13 to 17 are soldered or preferably welded to the stator winding ends 18 to 22.

The current rails 8 to 12 are arranged in an axis-parallel manner with respect to the middle axis of the electrical machine 1 and are positioned so that they correspond in their position with associated contact sites of a control device 6, as is illustrated in FIG. 1. In order overall to maintain a simple construction for the electrical connections, the stator winding ends 18 to 22 are arranged in accordance with the invention on the winding head 23 of the stator 2 at least almost in the identical angle position as the respective associated contact sites of the control device 6. Also, the radial spacing between the stator winding ends 18 to 22 and the respective associated contact sites at the control device 6 is kept as small as possible in order to be able to use correspondingly short clamping elements 13 to 17.

The rotor 24 that lies in the stator 2 and comprises a fan wheel 25 is evident in FIG. 2. A ball bearing 27 is assembled on the rotor shaft 26 and the rotor shaft 26 is mounted in a rotatable manner in said ball bearing.

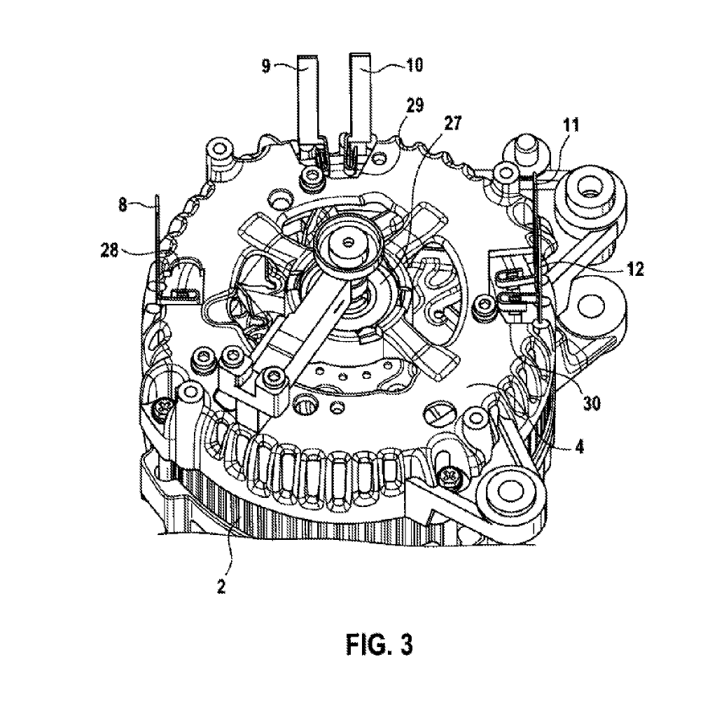

FIG. 3 illustrates, in addition to the illustration in FIG. 2, the assembled housing cover 4 of the stator 2 and the ball bearing 27 is lying in said housing cover. The current rails 8 to 12 engage through corresponding cut-outs 28 to 30 that are provided in the housing cover 4.

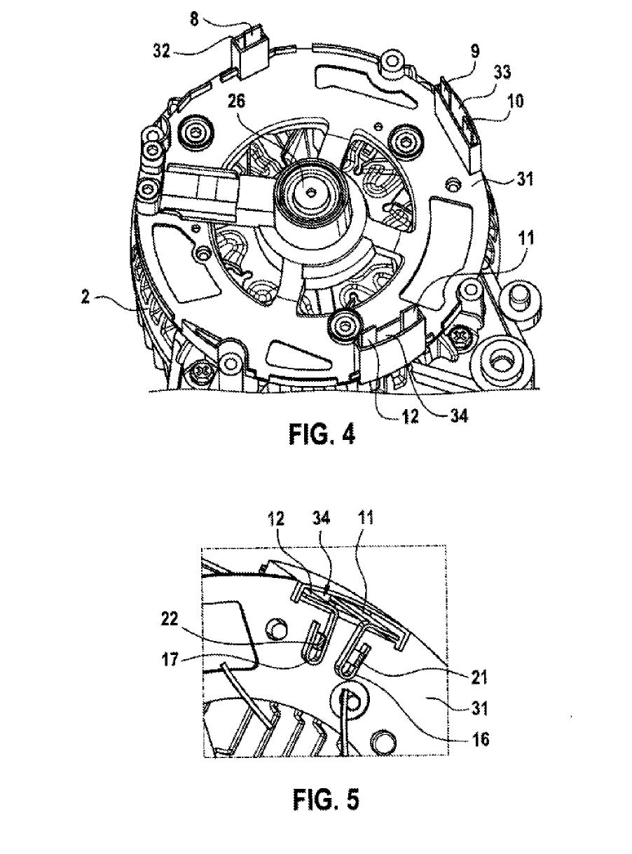

FIG. 4 illustrates a connection plate 31 that is embodied from an electrically non-conductive material and is placed on the housing cover 4 that is evident in FIG. 3; as an electrically insulating element, said connection plate is part of the connecting device in accordance with the invention. The connection plate 31 comprises three guide channels 32 to 34 and the current rails 8 to 12 that are arranged in an axis parallel manner are lying with a small amount of play in said guide channels. The connection plate 31 assumes a mechanical and electrical protective function for the current rails 8 to 12 that are lying therein.

The enlarged view shown in FIG. 5 illustrates the lower face of the connection plate 31 in the region of the current rails 11, 12. The current rails 11, 12 are lying in the guide channel 34 of the connection plate 31 and with their clamping elements 16, 17 engage the stator winding ends 21, 22 that are evident as a sectional view in this figure.

In the illustrated exemplary embodiment, the positions of the current rails 8 to 12 are selected so that they correspond with relevant contact sites of a control device. In FIG. 1, it is possible to provide on the control device 6 by way of example contact sites at the positions 35 to 39 that are covered by a rim covering 40. It is essential that the angle positions of the stator winding ends 18 to 22 (FIG. 2) and the angle positions of the contact sites that are arranged on the rim of the control device 6 essential correspond with one another so that current rails 8 to 12 can be used as electrical connecting elements as are illustrated in the FIGS. 2 to 5.

What is claimed is:

1. A connecting device having current rails (8-12) that produce an electrical connection between a stator winding and associated contact sites (35-39) of an electrical control device (6) of an electrical machine (1), said electrical control device being configured for controlling the stator winding, wherein the current rails (8-12) protrude at stator winding ends (18-22) in a parallel manner with respect to a middle axis of the electrical machine (1), and wherein the current rails (8-12) lie in guide channels (32-34) that are arranged on a connection plate (31) that is made of an electrically non-conductive material.

2. The connecting device according to claim 1, wherein each of the current rails (8-12) comprise at an end facing a stator winding end (18-22) a clamping element (13-17) with which the current rail (8-12) is fixedly clamped to the stator winding end (18-22).

3. The connecting device according to claim 2, wherein the clamping element (13-17) protrudes as a sheet metal bracket at an angle from the current rails (8-12).

4. The connecting device according to claim 1, wherein the guide channels (32-34) encompass with a small amount of play the current rails (8-12) that are lying in said guide channels.

5. The connecting device according to claim 1, wherein each of the current rails (8-12) is welded to a respective associated stator winding end (18-22).

6. The connecting device according to claim 1, wherein an angle position of the stator winding ends (18-22) that protrude at the stator winding in an axis-parallel manner with respect to the middle axis of the electrical machine (1) corresponds essentially to an angle position of the associated contact site of the control device (6).

7. The connecting device according to claim 1, wherein the stator winding ends (18-22) have a small radial spacing with respect to respective associated contact sites (35-39).

8. The connecting device according to claim 1, wherein all current rails (8-12) are identically embodied sheet metal parts.

9. The connecting device according to claim 1, wherein each current rail (8-12) is a straight sheet metal strip with a clamping element (13-17) formed thereon.

10. The connecting device according to claim 3, wherein the guide channels (32-34) encompass with a small amount of play the current rails (8-12) that are lying in said guide channels.

11. The connecting device according to claim 10, wherein each of the current rails (8-12) is welded to a respective associated stator winding end (18-22).

12. The connecting device according to claim 11, wherein an angle position of the stator winding ends (18-22) that protrude at the stator winding in an axis-parallel manner with respect to the middle axis of the electrical machine (1) corresponds essentially to an angle position of the associated contact site of the control device (6).

13. The connecting device according to claim 12, wherein the stator winding ends (18-22) have a small radial spacing with respect to respective associated contact sites (35-39).

14. The connecting device according to claim 13, wherein all current rails (8-12) are identically embodied sheet metal parts.

15. The connecting device according to claim 14, wherein each current rail (8-12) is a straight sheet metal strip with a clamping element (13-17) formed thereon.
